(19) United States
(12) Patent Application Publication
(10) Pub. No.: US 2016/0113336 A1
(43) Pub. Date: Apr. 28, 2016

(54) FACE MASK

(71) Applicant: UNI-CHARM CORPORATION, Shikokuchuo-shi (JP)

(72) Inventors: Akira SHIBATA, Kanonji-shi (JP); Makoto ISHIGAMI, Kanonji-shi (JP); Naohito TAKEUCHI, Kanonji-shi (JP)

(21) Appl. No.: 14/991,770

(22) Filed: Jan. 8, 2016

Related U.S. Application Data
(63) Continuation of application No. 13/388,463, filed on Apr. 10, 2012.

(30) Foreign Application Priority Data
Aug. 7, 2009 (JP) 2009-184045

(51) Int. Cl. A41D 13/11; A62B 23/02

(52) U.S. Cl. CPC A41D 13/1192; A41D 13/11; A62B 23/025; A41D 2400/52; A41D 2400/34

(57) ABSTRACT

A mask has a mask body and a pair of ear straps. The mask body includes an outer layer sheet and an intermediate layer sheet. The outer layer sheet is formed of hydrophobic fibers. The intermediate layer sheet is laid on the outer layer sheet so as to be located on a wearer's side of the outer layer sheet when the mask is worn. The intermediate layer sheet includes a first fiber layer which is formed of polyolefin fibers containing an inorganic antimicrobial agent and a second fiber layer which is formed of polyolefin fibers and has a larger fiber diameter than the first fiber layer. The fiber diameter of the first fiber layer is within a range of 0.5 to 2.8 μm and the ratio of a particle diameter of the inorganic antimicrobial agent with respect to the fiber diameter is within the range of 0.1 to 6.0.

The present application is a Continuation of U.S. patent application Ser. No. 13/388,463 filed on Apr. 10, 2012, which is a National Phase of International Application Number PCT/JP2010/063125, filed Aug. 3, 2010 and claims priority from Japanese Application Number 2009-184045, filed Aug. 7, 2009. The disclosures of all of the above-listed prior-filed applications are hereby incorporated by reference herein in their entirety.

### FIELD OF THE INVENTION

The present invention relates to a technique of constructing a mask to be worn on a wearer's face, and more particularly to a mask having antibacterial and antiviral effects.

### BACKGROUND OF THE INVENTION

Japanese laid-open Patent Publication No. 2007-37737 discloses a three-dimensional mask which covers wearer's mouth and nose. Recently, responding to rising consciousness of hygienic environment, and epidemics of colds and influenza and further to outbreaks of new infectious diseases such as avian influenza and coronavirus, masks having antibacterial and antiviral effects have been actively developed.

For example, Japanese laid-open Patent Publication Nos. 1993-153874 and 1996-325915 disclose nonwoven fabric which is formed of polyolefin fibers containing an inorganic antimicrobial agent. In this nonwoven fabric, however, most of the inorganic antimicrobial agent present inside of the fibers is covered with polyolefin, so that only a small amount of the inorganic antimicrobial agent is exposed to the fiber surface. Therefore, even if this nonwoven fabric is used to form a mask, the antibacterial and antiviral effects of the inorganic antimicrobial agent against pathogens such as bacteria and viruses are not fully achieved.

Further, when the mask is worn, the wearer may touch the mask body (mask cup). In this case, if any bacterium or virus adheres to the outer surface of the mask body and stays on it, the bacterium or virus may cause secondary infection. Therefore, in manufacturing a mask by using a fiber sheet containing an inorganic antimicrobial agent, a technique is desired to be provided by which antibacterial and antiviral effects of the inorganic antimicrobial agent are reliably achieved so as to prevent any bacterium or virus from staying on the outer surface of the mask body.

Further, in development of the mask of this type, in addition to high antibacterial and antiviral effects, it is also desired to realize such a high capture efficiency that the mask can capture dust or other particles in the air, and such a high air permeability that ease of breathing of the wearer can be enhanced, and to realize high productivity by provision of fibers which are unlikely to be broken during mask manufacturing.

### DISCLOSURE OF THE INVENTION

### Problems to be Solved by the Invention

It is, accordingly, an object of the present invention to provide an effective technique for preventing bacteria or viruses from staying on an outer surface of a mask body in order to achieve high antibacterial and antiviral effects, and for improving air permeability, capture efficiency and productivity.

### Means for Solving the Problem

In order to solve the above-described problem, the present invention as defined in each claim is provided.

A mask according to this invention is designed to be worn on a wearer's face and includes at least a mask body and a pair of ear straps. The mask may be of disposable type designed for a single or multiple use which can be used once or several times, or reusable type which can be reused by washing.

The mask body covers at least the mouth and nose (nostril) of a wearer. The pair of ear straps extend from both sides of the mask body and are designed to be hooked around wearer's ears. The ear straps are preferably formed of a stretch material so as to prevent excessive load on the ears. Further, the mask body is preferably formed of a material which is soft and comfortable to wear and has lower stretchiness than the ear straps so that the mask body lends itself to be retained in shape when the mask is worn on the face. The mask body may be planer or three-dimensional. In the case of a three-dimensional mask, it is essential for the mask body to take a three-dimensional shape at least when the mask is worn. (For example, the mask body may be designed to take a three-dimensional form when the mask is worn and to be folded into a planar form in a predetermined manner when the mask is not worn.) Therefore, the mask body may be designed to be three-dimensional not only when the mask is worn but when the mask is not worn. The mask body is a sheet-like structure formed by fixing or entangling fibers by mechanical, chemical or heat treatment. Typically, it is formed of nonwoven fabric which partly includes thermal melting (thermoplastic) fibers and thus can be heat-sealed (fusion bonded).

The mask body includes a first fiber sheet and a second fiber sheet. The first fiber sheet is formed of hydrophobic fibers (also referred to as “water-repellent fibers”). The second fiber sheet is laid on the first fiber sheet such that the second fiber sheet is located on the wearer's side of the first fiber sheet when the mask is worn. In this construction, the first fiber sheet forms the outer surface (side to be exposed to the air) of the mask. The mask body may have a two-layer structure having the first and second fiber sheets, or it may have a multilayer structure of three or more layers having the first and second fiber sheets and one or more additional fiber sheets.

Further, the second fiber sheet includes a first fiber layer and a second fiber layer. The first fiber layer is formed of polyolefin fibers containing an inorganic antimicrobial agent. Particularly in the first fiber layer, the fiber diameter is within a range of 0.5 to 2.8 μm and the ratio of a particle diameter of the inorganic antimicrobial agent with respect to this fiber diameter is within the range of 0.1 to 6.0. The second fiber layer is formed of polyolefin fibers having a larger fiber diameter than those of the first fiber layer. The second fiber sheet as a whole can secure desired antibacterial and antiviral effects via the first fiber layer and can secure desired capture efficiency (also referred to as “dust collecting efficiency”) and air permeability via the second fiber layer. In the second fiber sheet, the first fiber layer may be disposed on the first fiber sheet side (the outer side) of the second fiber layer, or the first fiber sheet may be disposed on the first fiber sheet side (the outer side) of the first fiber layer.

The second fiber sheet can be subjected to electret treatment as necessary. The “electret treatment” here is defined as a treatment for creating a dielectric state by providing a polyolefin fiber surface with a predetermined amount of positive or negative charge and polarizing it. By forming the mask having the electret second fiber sheet, the capture efficiency is further improved.

As the “inorganic antimicrobial agent” here, any inorganic antimicrobial agent can be used which is harmless to humans, not volatilized, not decomposed and not altered or deteriorated, for example, by heat during melt spinning of fibers, and has antibacterial and antiviral effects which are not deteriorated in a short period of time. Typically used are one or more kinds of an inorganic antimicrobial agent in which metal ions having antibacterial and antiviral effects, such as silver ions, copper ions and zinc ions, are supported by inorganic carriers, an inorganic antimicrobial agent of titanium oxide series, and other similar inorganic antimicrobial agents. As for the inorganic antimicrobial agent having antibacterial metal ions supported by inorganic carriers, the kind of inorganic carriers is not particularly limited, and any inorganic carrier which does not exhibit an effect of deteriorating a fiber sheet can be used. Suitably, inorganic carriers having ion-exchange capacity and metal-ion adsorption capacity and having high metal-ion retention capacity are used. Such inorganic carriers typically include zeolite, zirconium phosphate and calcium phosphate. Particularly, zeolite and zirconium phosphate having high ion-exchange capacity are most suitable.

Further, the “fiber layer formed of polyolefin fibers” widely includes not only a fiber layer formed only of polyolefin fibers, but a fiber layer formed of polyolefin fibers and other fibers in mixture. The polyolefin fiber typically includes polypropylene fiber, polyethylene fiber and poly 1-butene fiber.

With the mask having the above-described construction, when breathing of a mask wearer creates air flow from the mask outer surface toward the wearer's mouth, airborne droplets containing bacteria or viruses are led to the second fiber sheet without being absorbed by the first fiber sheet formed of hydrophobic fibers (without staying on the mask outer surface). Therefore, even if the wearer touches the mask body (mask cup) when putting on or off the mask, secondary infection can be prevented. Further, the evaluation tests conducted by inventors show that, by setting the fiber diameter of the first fiber layer and the ratio of the particle diameter of the inorganic antimicrobial agent with respect to the fiber diameter within the above-described respective appropriate ranges, high antibacterial and antiviral effects can be exerted and the air permeability, capture efficiency and productivity can be improved.

Particularly as for the antibacterial and antiviral effects, by providing such that the fiber diameter of the first fiber layer and the ratio of the particle diameter of the inorganic antimicrobial agent with respect to the fiber diameter are within the above-described respective appropriate ranges, compared with a construction in which they are not within the appropriate ranges, the inorganic antimicrobial agent can be effectively exposed onto the fiber surface, so that the inherent antibacterial and antiviral effects of the inorganic antimicrobial agent against pathogens such as bacteria and viruses can be fully exerted. Further, when it is designed and provided to have the same antibacterial and antiviral effects as a mask not having the above-described construction, the composition ratio of the inorganic antimicrobial agent can be reduced. Thus, the effect of reducing the product costs can be increased. Further, decrease of productivity due to fiber breakage can be prevented.

In the mask according to another aspect of this invention, the first fiber layer of the second fiber sheet is disposed on the first fiber sheet side of the second fiber layer. With such a construction, the inorganic antimicrobial agent in the first fiber layer can promptly exert an antibacterial effect on droplets containing bacteria or viruses which pass through the first fiber sheet.

In the mask according to another aspect of this invention, the first fiber sheet is formed of hydrophobic fibers having a fiber diameter of 10 to 40 μm and a pore size of 60 to 100 μm. With such a construction, the first fiber sheet has a low density and thus has increased air permeability, so that ease of breathing of the wearer is increased. Further, droplets containing bacteria or viruses are more easily led to the second fiber sheet.

In the mask according to another aspect of this invention, the mask body includes a bonding part which is formed between the first fiber sheet and the second fiber sheet by applying a hot-melt adhesive in fibrous form having a light basis weight of 1.0 to 3.0 g/m². The “hot-melt adhesive” here refers to an adhesive which contains no organic solvent mainly made of thermoplastic resin. Further, in “applying in fibrous form” here, typically, hot-melt resin fibers are applied to the bonded part at about equal intervals in meandering form in the direction of application. The diameter, shape and pattern of the fibers can be appropriately selected according to the kind and application conditions of the hot-melt resin. In a bonding part which is formed by applying an adhesive in film form, movement of droplets containing bacteria or viruses may be blocked so that the droplet guiding efficiency may be reduced. In this embodiment, however, the bonding part having a light basis weight has a function of preventing such decrease of the droplet guiding efficiency.

In the mask according to another aspect of this invention, the mask body includes a third fiber sheet that is laid on a side of the second fiber sheet facing away from the first fiber sheet, and the third fiber sheet is formed of fibers having a fiber diameter of 10 to 40 μm and a pore size of 60 to 100 μm. The third fiber sheet having a low density can be increased in air permeability so that ease of breathing of the wearer can be increased.

Other objects, features and advantages of the present invention will be readily understood after reading the following detailed description together with the accompanying drawings and the claims.

### Effect of the Invention

According to this invention, an effective technique for preventing bacteria or viruses from staying on an outer surface of a mask body in order to achieve high antibacterial and antiviral effects, and for improving air permeability, capture efficiency and productivity, can be provided in a mask to be worn on a wearer's face.

### BRIEF DESCRIPTION OF THE DRAWINGS

FIG. 1 is a perspective view of a mask 1 according to an embodiment of the invention.

FIG. 2 is a sectional view of a mask body 10 forming the mask 1.

### REPRESENTATIVE PREFERABLE EMBODIMENT FOR PERFORMING THE INVENTION

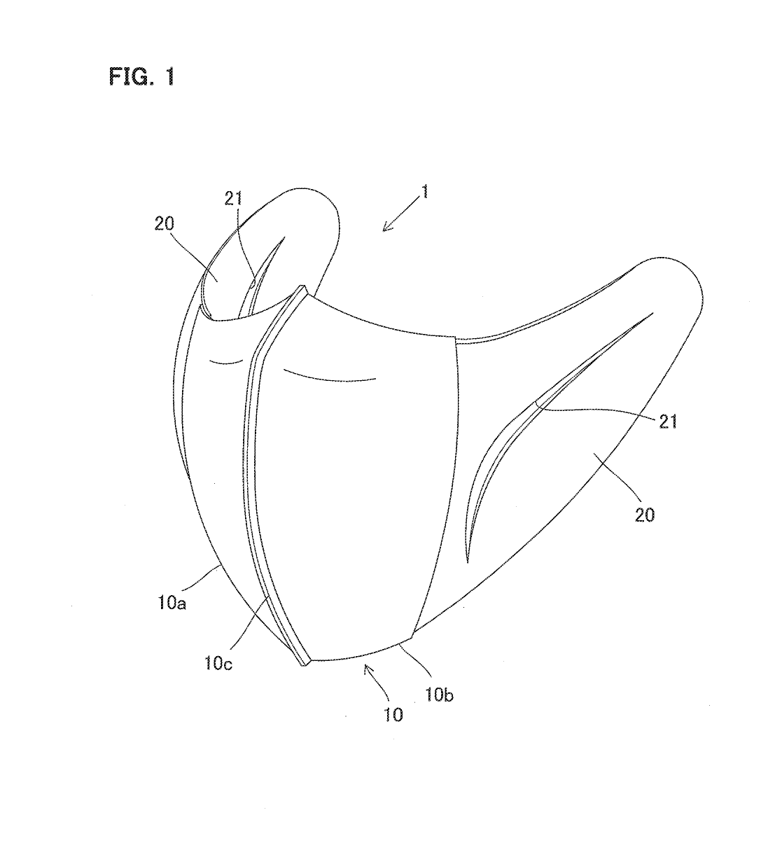

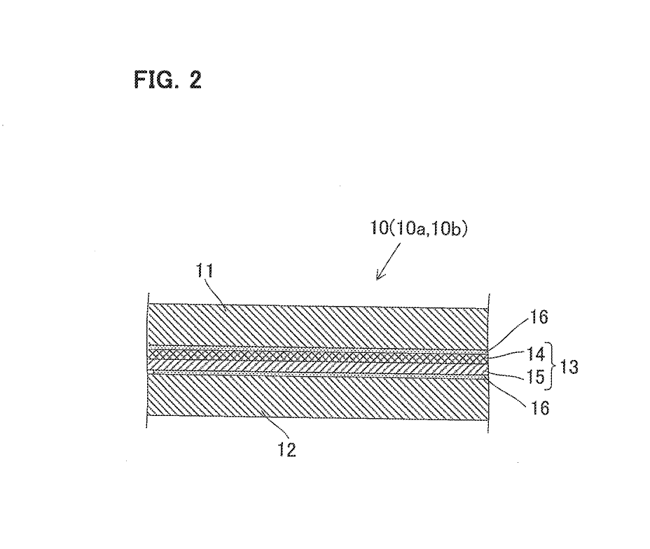

The construction of a mask 1 is described as a representative embodiment of the “mask” according to the present invention with reference to FIGS. 1 and 2.

Each of the additional features and method steps disclosed above and below may be utilized separately or in conjunction with other features and method steps to realize manufacturing and use of improved masks. Representative examples of this invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention.

FIG. 1 is a perspective view of the mask 1 according to this embodiment. The mask 1 shown in FIG. 1 is designed as a disposable mask for single or multiple use which can be used once or several times. The mask 1 is suitably used as a safeguard against viruses such as cold viruses, or against pollens as necessary. The mask 1 of this embodiment includes a mask body 10 and a pair of ear straps 20.

### (Mask Body 10)

The mask body 10 is designed to cover the mouth and nose (nostril) of a wearer. The mask body 10 corresponds in part or in entirety to the “mask body” according to this invention.

The mask body 10 includes a right sheet piece 10a that covers right half of the wearers face and a left sheet piece 10b that covers left half of the wearers face. The right and left sheet pieces 10a, 10b are bonded together by heat-sealing. A vertically extending bonding edge 10c is formed in a bonding region between the right and left sheet pieces 10a, 10b, so that the mask body 10 is divided into right and left halves by the bonding edge 10c. When the mask is worn, the mask body 10 forms a three-dimensional shape (three-dimensional structure) having a concave or cup-like form defined by a wearing face of the mask body 10 facing the wearer. The mask body 10 is also referred to as a “mouth covering part” or a “mask cup”.

When the mask is worn, the mask body 10 is unfolded into a three-dimensional form with the right and left sheet pieces 10a, 10b separated away from each other. When the mask is in storage or not in use, the mask body 10 folds flat such that the right and left sheet pieces 10a, 10b come in face contact with each other. Further, it is essential for the mask body 10 to form a three-dimensional form at least when the mask is worn. Therefore, the mask body 10 may be designed to be three-dimensional not only when the mask is worn but when the mask is not worn (not in use). Further, preferably, the mask body 10 has lower stretchiness than the ear straps 3 so that the mask body 10 lends itself to be retained in a three-dimensional form when the mask is worn.

The sectional structure of the mask body 10 (or the right and left sheet pieces 10a, 10b) is shown in FIG. 2. As shown in FIG. 2, the mask body 10 has an outer layer sheet 11 which is located on the outer side (faces away from the wearer's face) when the mask is worn, an inner layer sheet 12 which faces the wearer's face when the mask is worn, and an intermediate layer sheet 13 disposed between the outer layer sheet 11 and the inner layer sheet 12. Specifically, the mask body 10 has a three-layer structure in which the outer layer sheet 11 and the inner layer sheet 12 are laid on opposite sides of the intermediate layer sheet 13. Further, the intermediate layer sheet 13 is configured as a composite fiber sheet having a first fiber layer 14 and a second fiber layer 15 which are both formed of nonwoven fabric. Further, bonding parts 16 are provided between the outer layer sheet 11 and the intermediate layer sheet 13 and between the inner layer sheet 12 and the intermediate layer sheet 13. The outer layer sheet 11, the inner layer sheet 12 and the intermediate layer sheet 13 are features that correspond to the “first fiber sheet”, the “third fiber sheet” and the “second fiber sheet”, respectively, according to this invention.

Each of the outer layer sheet 11, the inner layer sheet 12 and the intermediate layer sheet 13 may be formed of one piece of nonwoven fabric sheet, or it may be formed of a plurality of nonwoven fabric sheets stacked in layers or butted and joined together.

The outer layer sheet 11 is formed as a low-density nonwoven fabric sheet (fiber sheet) having high hydrophobicity or water repellency (formed of hydrophobic fiber or water-repellent fiber). Typically used is a low-density pointbond nonwoven fabric sheet, containing polyethylene terephthalate fiber and polyethylene fiber and point-bonded by a pressure roll (for example, a nonwoven fabric sheet having an average fiber diameter of 10 to 40 μm, a pore size of 60 to 100 μm and a basis weight of 20 to 40 g/m²). By using such a low-density outer layer sheet 11, bacteria- or virus-containing droplets adhered to the outer layer sheet 11 are prevented from being absorbed onto the outer layer sheet 11 itself and are more easily led to the intermediate layer sheet 13. Further, the outer layer sheet 11 is increased in air permeability so that ease of breathing of the wearer is increased, and it is nice and soft. It is essential for the outer layer sheet 11 to have high hydrophobicity or water-repellency as a whole, and it is not necessary to be formed only of a highly hydrophobic or water-repellent fiber sheet.

The inner layer sheet 12 is formed as a low-density nonwoven fiber sheet. Typically used is a pointbond nonwoven fabric sheet of the same kind as used for the outer layer sheet 11. In this case, the nonwoven fiber sheet of the inner layer sheet 12 may have high hydrophobicity or water repellency, or it may have low hydrophobicity or water repellency. Such an inner layer sheet 12 is increased in air permeability so that ease of breathing of the wearer is increased, and it is nice and soft.

The first fiber layer 14 of the intermediate layer sheet 13 is formed as a nonwoven fabric layer formed of polyolefin fibers which are made of a polyolefinic resin composition (typically, polypropylene resin) containing a particulate inorganic antimicrobial agent. The first fiber layer 14 has a higher density than the outer layer sheet 11 and the inner layer sheet 12. Particularly, in the intermediate layer sheet 13 of this embodiment, the first fiber layer 14 is disposed on the outer layer sheet 11 side or the outer side of the second fiber layer 15. With such a construction, the particulate inorganic antimicrobial agent in the first fiber layer 14 can promptly exert an antibacterial effect on droplets containing bacteria or viruses which pass through the outer layer sheet 11. The first fiber layer 14 is a feature that corresponds to the “first fiber layer” according to this invention.

As the inorganic antimicrobial agent to be contained in the first fiber layer 14, any inorganic antimicrobial agent can be used which is harmless to humans, not volatilized, not decomposed and not altered or deteriorated, for example, by heat during melt spinning of fibers, and has antibacterial and antiviral effects which are not deteriorated in a short period of time. Typically used are one or more kinds of an inorganic antimicrobial agent in which metal ions having antibacterial and antiviral effects, such as silver ions, copper ions and zinc ions, are supported by inorganic carriers, an inorganic antimicrobial agent of titanium oxide series, and other similar inorganic antimicrobial agents. As for the inorganic antimicrobial agent having antibacterial metal ions supported by inorganic carriers, the kind of inorganic carriers is not particularly limited, and any inorganic carrier which does not exhibit an effect of deteriorating a fiber sheet can be used. Suitably, inorganic carriers having ion-exchange capacity and metal-ion adsorption capacity and having high metal-ion retention capacity are used. Such inorganic carriers typically include zeolite, zirconium phosphate and calcium phosphate. Particularly, zeolite and zirconium phosphate having high ion-exchange capacity are most suitable. The inorganic antimicrobial agent is a feature that corresponds to the “inorganic antimicrobial agent” according to this invention.

The second fiber layer 15 of the intermediate layer sheet 13 is formed as a nonwoven fabric layer formed of polyolefin fibers which do not contain an inorganic antimicrobial agent. The second fiber layer 15 has a higher density than the outer layer sheet 11 and the inner layer sheet 12. In the intermediate layer sheet 13 of this embodiment, the second fiber layer 15 is disposed on the inner layer sheet 12 side or the wearer's side. Further, the second fiber layer 15 has a larger fiber diameter (average fiber diameter) than the first fiber layer 14. With this construction, the intermediate layer sheet 13 as a whole can exert antibacterial and antiviral effects via the first fiber layer 14 and can secure desired capture efficiency (also referred to as “particle collecting efficiency”) and air permeability via the second fiber layer 15. Further, the first fiber layer 14 having a smaller fiber diameter than the second fiber layer 15 is securely retained by the second fiber layer 15. The second fiber layer 15 is a feature that corresponds to the “second fiber layer” according to this invention.

Each of the bonding parts 16 is formed by applying a hot-melt adhesive in fibrous form having a light basis weight (for example, 1.0 to 3.0 g/m²) to a bonded part. The “hot-melt adhesive” here refers to an adhesive which contains no organic solvent mainly made of thermoplastic resin. Further, in “applying in fibrous form” here, typically, hot-melt resin fibers are applied to the bonded part at about equal intervals in meandering form in the direction of application. The diameter, shape and pattern of the fibers can be appropriately selected according to the kind and application conditions of the hot-melt resin. In contrast to a bonding part which is formed by applying an adhesive in film form, the bonding part 16 having the above-described construction of a light basis weight has a function of preventing decrease of droplet guiding efficiency which may be caused by preventing movement of droplets containing bacteria or viruses. The bonding part 16 is a feature that corresponds to the “bonding part” according to this invention.

### (Ear Straps 20)

The ear straps 20 extend from right and left sides of the mask body 10 or from free ends of the right and left sheet pieces 10a, 10b. The ear strap 20 here is a feature that corresponds to the “ear strap” according to this invention. The ear straps 20 are formed separately from the mask body 10 and overlapped and bonded onto the mask body 2. The ear straps 20 may be integrally formed with the mask body 10. Further, each of the ear straps 20 has a ring-like shape having an opening 21. When the mask is worn, the opening 21 of the ear strap 20 is hooked around the wearer's ear with the wearer's face, or particularly the nose and mouth, covered with the mask body 10.

Like the mask body 10, the ear strap 20 is formed of nonwoven fabric of thermoplastic synthetic fibers. Preferably, the ear strap 20 is formed of a stretch material so as to prevent excessive load on the ear. For example, the ear strap 20 suitably has a stretch layer of inelastically extensible fibers (for example, nonwoven fabric formed by heat-sealing propylene continuous fibers) and an elastic layer of elastically stretchable fibers (for example, nonwoven fabric formed by using elastic yarn of thermoplastic synthetic fibers such as elastomer and urethane) which are laid one on the other.

An example of a method of manufacturing the intermediate layer sheet 13 and the mask body 10 is now described. This manufacturing method has the following steps 1 to 4.

### (Step 1)

Polypropylene (having the melt flow rate (MFR) of 700 g/10 min) is subjected to meltblow spinning process at the spinning temperature of 280° C., the air temperature of 290° C., the air pressure of 1.2 kg/cm² and the amount of discharge per pore of 0.4 g/min, with a nozzle having 2,850 spinning pores (in a linear arrangement) and at the capture distance of 30 cm by using a conventional meltblow (or called as “meltblown”) apparatus. In this manner, a nonwoven fabric layer (the second fiber layer 15) having a predetermined basis weight and a predetermined fiber diameter (average fiber diameter) is manufactured.

### (Step 2)

A master batch containing a silver inorganic antimicrobial agent is prepared by combination of 80 parts by mass of polypropylene (α) (MFR=700 g/10 min) and 20 parts by mass of the silver inorganic antimicrobial agent (TOAGOSEI's “NOVARON AG300”, 1 μm in average particle diameter, generally cubic) in which silver ions are supported by inorganic ion exchangers mainly made of zirconium phosphate. The prepared master batch and polypropylene (13)=700 g/10 min) are mixed at the mass ratio of 1:1 and then subjected to meltblow spinning process on the nonwoven fabric layer (the second fiber layer 15) manufactured in the above-described step 1, at the spinning temperature of 280° C., the air temperature of 290° C., the air pressure of 1.2 kg/cm² and the amount of discharge per pore of 0.4 g/min, with a nozzle having 2,850 spinning pores (in a linear arrangement) by using a conventional meltblow apparatus. In this manner, another nonwoven fabric layer (the first fiber layer 14) is formed. Thus, a composite fiber sheet having the first fiber layer 14 and the second fiber layer 15 is manufactured.

### (Step 3)

The composite fiber sheet obtained in the above-described step 2 is subjected to electret treatment by using a conventional electret apparatus under the conditions that the distance between a needle electrode and a roll electrode is 25 mm, the applied voltage is −25 KV and the temperature is 80° C. In this manner, a charged composite fiber sheet (the intermediate sheet 13) is manufactured. By this electret treatment, the surface of the polypropylene fiber is provided with a predetermined amount of positive or negative charge and turns into a polarized dielectric state. The mask formed of such an electret composite fiber sheet can be further improved in capture efficiency or dust collecting efficiency.

In this embodiment, because the first and second fiber layers 14, 15 are formed of one kind of polyolefin fibers, or particularly, polypropylene fibers, their electret treatment can be particularly easily performed, and a low-cost mask can be provided which is advantageous in terms of cost. Further, the first and second fiber layers 14, 15 may be formed of polyolefin fibers other than polypropylene fibers, such as polyethylene fibers and poly 1-butene fibers.

### (Step 4)

A hot-melt adhesive is applied in fibrous form having a light basis weight (e.g. 1.0 to 3.0 g/m²) to one side of the charged composite fiber sheet (the intermediate sheet 13) obtained in the above-described step 3, and then the outer layer sheet 11 is placed on this side. Further, the hot-melt adhesive is applied in fibrous form having a light basis weight (e.g. 1.0 to 3.0 g/m²) to the other side of the charged composite fiber sheet (the intermediate sheet 13), and then the inner layer sheet 12 is placed on this side. In this manner, the mask body 10 is manufactured.

In a mask which is formed of polyolefin fibers containing a particulate inorganic antimicrobial agent like the mask 1 of this embodiment, most of the inorganic antimicrobial agent present inside of the fibers is covered with polyolefin, so that only a small amount of the inorganic antimicrobial agent is exposed to the fiber surface. Therefore, the inherent antibacterial and antiviral effects of the inorganic antimicrobial agent are not fully achieved. In order to solve this problem, inventors have focused on the relationship between the fiber diameter of the polyolefin fibers containing the inorganic antimicrobial agent and the particle diameter of the inorganic antimicrobial agent and successfully found that the inherent antibacterial and antiviral effects of the inorganic antimicrobial agent can be achieved, while securing the capture efficiency and air permeability, by setting values relating to the fiber diameter of the polyolefin fibers and the particle diameter of the inorganic antimicrobial agent within their respective specified ranges.

Performance of a mask was evaluated by varying the construction of the mask body 10. For evaluation of mask performance, specimens of the following examples 1 to 10 and comparative examples 1 to 10 representing the mask body 10 were prepared.

In each of the specimens, non-electret polyethylene terephthalate/polyethylene pointbond nonwoven fabric sheet (average fiber diameter: 17 μm, basis weight: 32 g/m²) was used as the outer layer sheet 11 and the inner layer sheet 12. Further, the particle diameter of the inorganic antimicrobial agent, and the fiber diameter, basis weight and pore size of the fiber layer were measured as follows.

### (Particle Diameter of Inorganic Antimicrobial Agent)

Water is added to the particulate inorganic antimicrobial agent (silver-based inorganic antimicrobial agent) contained in the first fiber layer 14 and stirred well enough for the agent to be uniformly dispersed in the water. Particle size distribution of the dispersed liquid is measured by using a laser diffraction/scattering particle size distribution analyzer (HORIBA's “LA-920”). At this time, prior to measurement of the particle size distribution of the dispersed liquid, the dispersed liquid is radiated with ultrasound for one minute by using an ultrasonic homogenizer built into the measuring device. An arithmetic mean value (μm) is then calculated from the particle size distribution on the volumetric basis and defined as an average particle diameter of the inorganic antimicrobial agent. The calculated average particle diameter of the inorganic antimicrobial agent is defined as the particle diameter of the inorganic antimicrobial agent contained in the first fiber layer 14.

### (Fiber Diameter)

A square specimen (5 cm×5 cm) is obtained from the first fiber layer 14 (the second fiber layer 15) made of polyolefin fibers. The central portion (around the intersection of the diagonal lines) of the surface of the obtained specimen is then photographed at 1000-fold magnification by using a scanning electron microscope (SEM). On this photo, a circle with a radius of 15 cm is drawn around the center (the intersection of the diagonal lines) of the photo. Subsequently, the fiber diameter of all (commonly about 50 to 100) non-heat-sealed polyolefin fibers within this circle is measured at the middle in the length direction or its vicinity with calipers. The mean value of the measured fiber diameter is defined as the average fiber diameter (μm) of the polyolefin fibers. The obtained average fiber diameter of the polyolefin fibers is defined as the fiber diameter of the first fiber layer 14 (the second fiber layer 15).

In obtaining the average fiber diameter of the polyolefin fibers, the fiber diameter of all polyolefin fibers in the photo is measured without distinguishing whether the polyolefin fibers in the photo are located on the outermost surface of the first fiber layer 14 (the second fiber layer 15) or on its inner side, and the average of the measurements is obtained. The specimen of the first fiber layer 14 (the second fiber layer 15) may also have a size other than that (5 cm×5 cm) described above, as necessary.

### (Basis Weight)

As for the basis weight of the second fiber layer 15, a square specimen (20 cm×20 cm) is obtained from nonwoven fabric used as the second fiber layer 15. The basis weight of the obtained specimen is measured at three points along the width direction of the specimen in accordance with JIS L1906 (Test methods for nonwoven fabrics made of filament yarn), and the mean value of the measured basis weight is defined as the basis weight of the second fiber layer 15.

As for the basis weight of the intermediate-layer sheet 13, a square specimen (20 cm×20 cm) is obtained from the intermediate-layer sheet 13. The basis weight of the obtained specimen is measured at three points along the width direction of the specimen in accordance with JIS L1906 (Test methods for nonwoven fabrics made of filament yarn), and the mean value of the measured basis weight is defined as the basis weight of the whole intermediate-layer sheet 13.

As for the basis weight of the first fiber layer 14, the value obtained by subtracting the calculated basis weight of the second fiber layer 15 from the basis weight of the whole intermediate-layer sheet 13 is defined as the basis weight of the first fiber layer 14.

The specimens of the second fiber layer 15 and the intermediate-layer sheet 13 may also have a size other than that (20 cm×20 cm) described above, as necessary.

### (Pore Size)

As for the pore size, a circular specimen 42.5 mm in diameter is obtained from the mask body (mouth covering part) 10. The average pore size of the obtained specimen is measured by using a known measuring device (Porous Materials, Inc.'s Automated Perm Porometer), and the measured average pore size is defined as the pore size. In this manner, the pore size of fibers forming, for example, the outer layer sheet 11 and the inner layer sheet 12 can be measured.

### Example 1

As for a specimen of example 1, a polypropylene meltblow nonwoven fabric sheet (fiber diameter: 1.5 μm, basis weight: 1.5 g/m², particle diameter of the inorganic antimicrobial agent: 1.0 μm, particle diameter of the inorganic antimicrobial agent/fiber diameter: 0.7) is used as the nonwoven fabric sheet corresponding to the first fiber layer 14 of the intermediate-layer sheet 13. Further, a polypropylene meltblow nonwoven fabric sheet (fiber diameter: 3.5 μm, basis weight: 15 g/m²) is used as the nonwoven fabric sheet corresponding to the second fiber layer 15 of the intermediate-layer sheet 13. This specimen has the total basis weight of 84.1 g/m² and contains the inorganic antimicrobial agent of 0.15 g/m².

### Example 2

As for a specimen of example 2, a polypropylene meltblow nonwoven fabric sheet (fiber diameter: 0.5 μm, basis weight: 1.5 g/m², particle diameter of the inorganic antimicrobial agent: 0.2 μm, particle diameter of the inorganic antimicrobial agent/fiber diameter: 0.4) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount (g/m²) of the inorganic antimicrobial agent as the specimen of example 1.

### Example 3

As for a specimen of example 3, a polypropylene meltblow nonwoven fabric sheet (fiber diameter: 1.5 μm, basis weight: 1.5 g/m², particle diameter of the inorganic antimicrobial agent: 0.2 μm, particle diameter of the inorganic antimicrobial agent/fiber diameter: 0.13) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 4

As for a specimen of example 4, a polypropylene meltblow nonwoven fabric sheet (fiber diameter: 2.0 μm, basis weight: 1.0 g/m², particle diameter of the inorganic antimicrobial agent: 0.2 μm, particle diameter of the inorganic antimicrobial agent/fiber diameter: 0.1) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 5

As for a specimen of example 5, a polypropylene meltblow nonwoven fabric sheet (fiber diameter: 0.5 μm, basis weight: 1.0 g/m², particle diameter of the inorganic antimicrobial agent: 1.0 μm, particle diameter of the inorganic antimicrobial agent/fiber diameter: 2.0) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 6

As for a specimen of example 6, a polypropylene meltblow nonwoven fabric sheet (fiber diameter: 2.8 μm, basis weight: 1.0 g/m², particle diameter of the inorganic antimicrobial agent: 1.0 μm, particle diameter of the inorganic antimicrobial agent/fiber diameter: 0.36) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 7

As for a specimen of example 7, a polypropylene meltblow nonwoven fabric sheet (fiber diameter: 0.5 μm, basis weight: 1.0 g/m², particle diameter of the inorganic antimicrobial agent: 3.0 μm, particle diameter of the inorganic antimicrobial agent/fiber diameter: 6.0) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 8

As for a specimen of example 8, a polypropylene meltblow nonwoven fabric sheet (fiber diameter: 1.0 μm, basis weight: 1.0 g/m², particle diameter of the inorganic antimicrobial agent: 6.0 μm, particle diameter of the inorganic antimicrobial agent/fiber diameter: 6.0) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 9

As for a specimen of example 9, a polypropylene meltblow nonwoven fabric sheet (fiber diameter: 1.5 μm, basis weight: 1.0 g/m², particle diameter of the inorganic antimicrobial agent: 6.0 μm, particle diameter of the inorganic antimicrobial agent/fiber diameter: 4.0) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Example 10

As for a specimen of example 10, a polypropylene meltblow nonwoven fabric sheet (fiber diameter: 2.8 μm, basis weight: 1.0 g/m², particle diameter of the inorganic antimicrobial agent: 6.0 μm, particle diameter of the inorganic antimicrobial agent/fiber diameter: 2.1) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen also has the same total basis weight and contains the same amount of the inorganic antimicrobial agent as the specimen of example 1.

### Comparative Example 1

As for a specimen of comparative example 1, the intermediate-layer sheet 13 is formed only by a nonwoven fabric sheet having a single fiber layer, and a polypropylene meltblow nonwoven fabric sheet (fiber diameter: 3.5 μm, basis weight: 18 g/m², particle diameter of the inorganic antimicrobial agent: 1.0 μm) is used as the nonwoven fabric sheet. This specimen has the total basis weight of 85.6 g/m² and contains the inorganic antimicrobial agent of 0.30 g/m².

### Comparative Example 2

As for a specimen of comparative example 2, a polypropylene meltblow nonwoven fabric sheet (fiber diameter: 0.4 μm, basis weight: 1.5 g/m², particle diameter of the inorganic antimicrobial agent: 0.1 μm, particle diameter of the inorganic antimicrobial agent/fiber diameter: 0.25) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 3

As for a specimen of comparative example 3, a polypropylene meltblow nonwoven fabric sheet (fiber diameter: 1.5 μm, basis weight: 1.5 g/m², particle diameter of the inorganic antimicrobial agent: 0.1 μm, particle diameter of the inorganic antimicrobial agent/fiber diameter: 0.07) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 4

As for a specimen of comparative example 4, a polypropylene meltblow nonwoven fabric sheet (fiber diameter: 2.5 μm, basis weight: 1.5 g/m², particle diameter of the inorganic antimicrobial agent: 0.2 μm, particle diameter of the inorganic antimicrobial agent/fiber diameter: 0.08) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 5

As for a specimen of comparative example 5, a polypropylene meltblow nonwoven fabric sheet (fiber diameter: 0.4 μm, basis weight: 1.5 g/m², particle diameter of the inorganic antimicrobial agent: 1.0 μm, particle diameter of the inorganic antimicrobial agent/fiber diameter: 2.5) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 6

As for a specimen of comparative example 6, a polypropylene meltblow nonwoven fabric sheet (fiber diameter: 3.0 μm, basis weight: 1.5 g/m², particle diameter of the inorganic antimicrobial agent: 1.0 μm, particle diameter of the inorganic antimicrobial agent/fiber diameter: 0.3) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 7

As for a specimen of comparative example 7, a polypropylene meltblow nonwoven fabric sheet (fiber diameter: 0.4 μm, basis weight: 1.5 g/m², particle diameter of the inorganic antimicrobial agent: 3.0 μm, particle diameter of the inorganic antimicrobial agent/fiber diameter: 7.5) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 8

As for a specimen of comparative example 8, a polypropylene meltblow nonwoven fabric sheet (fiber diameter: 0.9 μm, basis weight: 1.5 g/m², particle diameter of the inorganic antimicrobial agent: 6.0 μm, particle diameter of the inorganic antimicrobial agent/fiber diameter: 6.7) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 9

As for a specimen of comparative example 9, a polypropylene meltblow nonwoven fabric sheet (fiber diameter: 1.5 μm, basis weight: 1.5 g/m², particle diameter of the inorganic antimicrobial agent: 7.0 μm, particle diameter of the inorganic antimicrobial agent/fiber diameter: 4.7) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### Comparative Example 10

As for a specimen of comparative example 10, a polypropylene meltblow nonwoven fabric sheet (fiber diameter: 3.0 μm, basis weight: 1.5 g/m², particle diameter of the inorganic antimicrobial agent: 7.0 μm, particle diameter of the inorganic antimicrobial agent/fiber diameter: 2.3) is used as the nonwoven fabric sheet corresponding to the first fiber layer 14 of the intermediate-layer sheet 13. Further, as the nonwoven fabric sheet corresponding to the second fiber layer 15 of the intermediate-layer sheet 13, the same nonwoven fabric sheet as in the specimen of example 1 is used. This specimen has the same total basis weight and contains the same amount of the inorganic antimicrobial agent as the specimen of example 1.

### (Derivation and Evaluation of Air Permeability)

For measurement of air permeability, a specimen of 40 mm or longer in height and width was obtained from the mask body (mouth covering part). The air permeability is preferably measured only in a meltblow layer (filter layer), but in the case of a specimen in which the meltblow layer is bonded with any other layer by an ultrasonic seal, a heat seal, an adhesive or other similar bonding methods, the measurement is conducted in a minimum number of layers including the meltblow layer. The air permeability was measured by using an Automatic Air-Permeability Tester (Kato Tech's “KES-F8-AP1”). Specifically, the tester discharged air onto the specimen (discharge mode) and sucked air from the specimen (intake mode) at a flow rate of 4 cc/cm²/sec (area: 2π×10⁻⁴ m²). After 3 seconds of the discharge mode and 3 seconds of the intake mode, the pressure loss was measured by using a semiconductor type differential pressure gauge. The air permeability (cc/cm²/sec) was then obtained from the integral of the measurement.

Further, based on the obtained air permeability (cc/cm²/sec), the air permeability was assessed in three levels of ◯, Δ, x. The air permeability (cc/cm²/sec) of 0.41 or lower was assessed as ◯, 0.42 to 0.45 as Δ, and 0.46 or higher as x.

### (Derivation and Evaluation of Bacterial Filtration Efficiency (BFE))

For measurement of bacterial filtration efficiency (BFE), a specimen of 90 mm or longer in height and width was obtained from the mask body (mouth covering part). When a specimen of this size could not be obtained from the mask body (mouth covering part), a plurality of specimens were obtained and rectilinearly bonded together along their overlapped edges by ultrasonic sealing or heat sealing such that a specimen of 90 mm or longer in height and width was obtained. The bacterial filtration efficiency is preferably measured only in a meltblow layer (filter layer), but in the case of a specimen having a composite layer of the meltblow layer and any other layer (e.g. spunbond layer), the measurement was conducted in a minimum unit including the meltblow layer. The bacterial filtration efficiency (BFE) was measured in accordance with ASTM F2101-07. The bacterial filtration efficiency (BFE) was obtained from the following equation:

bacterial filtration efficiency (BFE) (%)={(A−B)/A}×100,

where A is the average number of control colonies, and B is the average number of sample colonies.

Further, based on this bacterial filtration efficiency (BFE), the filtration efficiency was assessed in three levels of ◯, Δ, x. The bacterial filtration efficiency (BFE) of 95% or higher was assessed as ◯, the bacterial filtration efficiency of 90 to 94% as Δ, and the bacterial filtration efficiency of 89% or lower as x.

### (Testing for Antibacterial Activity)

For testing for antibacterial activity, 0.4 gram of an antibacterial finished portion of the mask body (mouth covering part) was obtained as a specimen. This testing was conducted in accordance with the absorption method of RS L1902, and the antibacterial efficacy (activity value) was measured. This testing was considered valid when the growth value of the viable bacteria count is 1.0 or higher, and the bacteriostasis activity value was measured as the above-described activity value. It was considered as having antibacterial effects when the bacteriostasis activity value is 2.0 or higher.

### (Derivation and Evaluation of Virus Decrease Rate)

In an influenza virus inactivation test relating to virus decrease rate, when a specimen is water-repellent, it must be impregnated with sterile distilled water. Therefore, a specimen obtained from the mask body (mouth covering part) was subjected to a hydrophilizing process in advance by using Tween 80 as an activator in the following procedure. Tween 80 having the solution concentration of 0.05% is used. Tween 80 is hard to dissolve, so that it should be melted over low heat by using a magnetic stirrer with a heater, or first dissolved in hot water. Then the specimen to be hydrophilized is immersed in this liquid and dried in an oven at 90° C.

This testing was conducted as follows:

Influenza virus A/H1N1 was used as the virus being tested.

The influenza virus was inoculated into the allantoic cavity of an embryonated chicken egg and cultured in an incubator. Then the allantoic fluid was removed and the virus liquid was purified from the allantoic fluid by density gradient centrifugation and used as the virus being tested. The virus culture time setting was 24 hours.

The specimen cut into 4 cm squares was placed in a plastic petri dish, and 0.2 ml of the virus liquid being tested was added to the specimen. Further, the upper side of the specimen was covered with a film of 4 cm squares, so that the contact efficiency of the virus and the specimen is enhanced. After letting the virus sit (culture) for 24 hours at room temperature, the specimen and the film were transferred into a centrifuging tube containing 5 ml of phosphate buffered saline (PBS). Then it was mixed for 30 seconds with a vortex mixer, so that the test virus was washed away from the specimen. In this manner, a quantitative test specimen was obtained.

The specimen may also have a size other than that (4 cm×4 cm) described above, as necessary.

A ten-fold serial dilution of the above-described quantitative test specimen as stock solution in PBS was performed. The diluted virus solution and MDCK (Madin-Darby canine kidney) cells were seeded in a 96-well plate and cultured for five days in a carbon dioxide incubator of 37° C. Subsequently, the cells in the wells were fixed and stained with 4% formalin and 0.1% crystal violet and rinsed in water. The wells were then dried and 50 ml of ethanol was added to each well. The absorbance (585 nm of peak wavelength) of crystal violet eluted from stained uninfected cells was determined, and the virus infectivity titer TCID50 (median tissue culture infectious dose) was obtained. Thus the TCID50 per one specimen was calculated.

Based on the ratio of the calculated infectivity titer of the virus obtained after 24 hours with respect to a blank value, the virus decrease rate was obtained from the following equation:

virus decrease rate (%)=100−{(virus infectivity titer after 24 hrs)/(blank value)}

Further, based on the calculated virus decrease rate (%), the antiviral efficacy was assessed in three levels of ◯, Δ, x. The virus decrease rate of 90% or higher was assessed as ◯, 11 to 89% as Δ, and 10% or lower as x.

Based on the above-described various derived measurements, the specimens of examples 1 to 10 and comparative examples 1 to 10 were evaluated as follows:

### (Evaluation Results of Examples 1 to 10)

The specimen of example 1 has the virus decrease rate of 99.9%, air permeability of 0.413 cc/cm²/sec and BFE of 99.1%.

The specimen of example 2 has the virus decrease rate of 99.9%, air permeability of 0.421 cc/cm²/sec and BFE of 99.3%.

The specimen of example 3 has the virus decrease rate of 90.2%, air permeability of 0.414 cc/cm²/sec and BFE of 99.1%.

The specimen of example 4 has the virus decrease rate of 90.0%, air permeability of 0.409 cc/cm²/sec and BFE of 99.0%.

The specimen of example 5 has the virus decrease rate of 99.9%, air permeability of 0.422 cc/cm²/sec and BFE of 99.3%.

The specimen of example 6 has the virus decrease rate of 94.5%, air permeability of 0.401 cc/cm²/sec and BFE of 98.1%.

The specimen of example 7 has the virus decrease rate of 99.9%, air permeability of 0.420 cc/cm²/sec and BFE of 99.0%.

The specimen of example 8 has the virus decrease rate of 99.9%, air permeability of 0.416 cc/cm²/sec and BFE of 99.1%.

The specimen of example 9 has the virus decrease rate of 99.9%, air permeability of 0.413 cc/cm²/sec and BFE of 99.3%.

The specimen of example 10 has the virus decrease rate of 99.9%, air permeability of 0.402 cc/cm²/sec and BFE of 97.0%.

All of the specimens of examples 1 to 10 were assessed as ◯ in all of antiviral efficacy, air permeability and capture efficiency. Specifically, it was verified that they are effective in providing a mask having high antibacterial and antiviral effects and high air permeability and capture efficiency. Further, all of the specimens of examples 1 to 10 also provide high enough production efficiency without causing such a problem of fiber breakage which may decrease the production efficiency.

### (Evaluation Results of Comparative Example 1)

The specimen of comparative example 1 has the virus decrease rate of 15.0%, air permeability of 0.412 cc/cm²/sec and BFE of 96.1%. Specifically, in the specimen of comparative example 1, the antimicrobial agent is particularly hard to be exposed to the fiber surface and the nonwoven fabric surface, and the antiviral efficacy was assessed as Δ. Therefore, it was verified that the specimen of comparative example 1 has lower antibacterial and antiviral effects than examples 1 to 10.

### (Evaluation Results of Comparative Example 2)

The specimen of comparative example 2 has the virus decrease rate of 10.0%, air permeability of 0.433 cc/cm²/sec and BFE of 97.3%. Specifically, in the specimen of comparative example 2, the antimicrobial agent is particularly hard to be exposed to the fiber surface and the nonwoven fabric surface, and the antiviral efficacy was assessed as x. Therefore, it was verified that the specimen of comparative example 2 has lower antibacterial and antiviral effects than examples 1 to 10. Further, fibers of the specimen of comparative example 2 having a small fiber diameter are easy to break, so that stable productivity cannot be obtained.

### (Evaluation Results of Comparative Example 3)

The specimen of comparative example 3 has the virus decrease rate of 10.0%, air permeability of 0.414 cc/cm²/sec and BFE of 97.1%. Specifically, in the specimen of comparative example 3, the antimicrobial agent is particularly hard to be exposed to the fiber surface and the nonwoven fabric surface, and the antiviral efficacy was assessed as x. Therefore, it was verified that the specimen of comparative example 3 has lower antibacterial and antiviral effects than examples 1 to 10.

### (Evaluation Results of Comparative Example 4)

The specimen of comparative example 4 has the virus decrease rate of 12.0%, air permeability of 0.405 cc/cm²/sec and BFE, of 96.0%. Specifically, in the specimen of comparative example 4, the antimicrobial agent is particularly hard to be exposed to the fiber surface and the nonwoven fabric surface, and the antiviral efficacy was assessed as Δ. Therefore, it was verified that the specimen of comparative example 4 has lower antibacterial and antiviral effects than examples 1 to 10.

### (Evaluation Results of Comparative Example 5)

The specimen of comparative example 5 has the virus decrease rate of 70.0%, air permeability of 0.434 cc/cm²/sec and BFE, of 97.0%. Specifically, in the specimen of comparative example 5, the antimicrobial agent is particularly hard to be exposed to the fiber surface and the nonwoven fabric surface, and the antiviral efficacy was assessed as Δ. Therefore, it was verified that the specimen of comparative example 5 has lower antibacterial and antiviral effects than examples 1 to 10. Further, fibers of the specimen of comparative example 2 having a small fiber diameter are easy to break, so that stable productivity cannot be obtained.

### (Evaluation Results of Comparative Example 6)

The specimen of comparative example 6 has the virus decrease rate of 10.0%, air permeability of 0.402 cc/cm²/sec and BFE of 96.8%. Specifically, in the specimen of comparative example 6, the antimicrobial agent is particularly hard to be exposed to the fiber surface and the nonwoven fabric surface, and the antiviral efficacy was assessed as Δ. Therefore, it was verified that the specimen of comparative example 6 has lower antibacterial and antiviral effects than examples 1 to 10. Further, the capture efficiency of comparative example 6 was assessed as Δ, and it was verified that the specimen of comparative example 6 has lower capture efficiency than examples 1 to 10.

### (Evaluation Results of Comparative Example 7)

The specimen of comparative example 7 has the virus decrease rate of 98.0%, air permeability of 0.408 cc/cm²/sec and BFE of 95.0%. Specifically, the specimen of comparative example 7 has high antivirus efficacy, air permeability and capture efficiency, but it has demerits that fibers having a small fiber diameter are easy to break, so that stable productivity cannot be obtained.

### (Evaluation Results of Comparative Example 8)

The specimen of comparative example 8 has the virus decrease rate of 99.0%, air permeability of 0.407 cc/cm²/sec and BFE of 91.3%. Specifically, the capture efficiency of comparative example 8 was assessed as Δ, and it was verified that the specimen of comparative example 8 has lower capture efficiency than examples 1 to 10.

### (Evaluation Results of Comparative Example 9)

The specimen of comparative example 9 has the virus decrease rate of 99.0%, air permeability of 0.411 cc/cm²/sec and BFE, of 92.0%. Specifically, the capture efficiency of the comparative example 9 was assessed as Δ, and it was verified that the specimen of comparative example 9 has lower capture efficiency than examples 1 to 10. Further, fibers of the specimen of comparative example 9 having a small fiber diameter are easy to break, so that stable productivity cannot be obtained.

### (Evaluation Results of Comparative Example 10)

The specimen of comparative example 10 has the virus decrease rate of 99.0%, air permeability of 0.401 cc/cm²/sec and BFE, of 95.9%. Specifically, the capture efficiency of the comparative example 10 was assessed as Δ, and it was verified that the specimen of comparative example 10 has lower capture efficiency than examples 1 to 10.

By provision of the above-described construction, when breathing of a mask wearer creates air flow from the mask outer surface toward the wearer's mouth, airborne droplets containing bacteria or viruses are led to the intermediate-layer sheet 13 without being absorbed by the outer layer sheet 11 formed of hydrophobic fibers or water-repellent fibers (without staying on the mask outer surface). Therefore, even if the wearer touches the mask body (mask cup) when putting on or off the mask, secondary infection can be prevented.

Further, from the above-described evaluation results of specimens of examples 1 to 10 and comparative examples 1 to 10, in order to realize high antibacterial and antiviral effects and to improve air permeability, capture efficiency and productivity, the fiber diameter of the first fiber layer 14 of the intermediate-layer sheet 13 is set within the range of 0.5 to 2.8 μm and the ratio of the particle diameter of the inorganic antimicrobial agent with respect to the fiber diameter is set within the range of 0.1 to 6.0, or the fiber diameter of the first fiber layer 14 of the intermediate-layer sheet 13 is set within the range of 0.5 to 2.8 μm and the particle diameter of the inorganic antimicrobial agent is set within the range of 0.2 to 6.0 μm.

Particularly as for the antibacterial and antiviral effects, by provision of the above-described construction, the inorganic antimicrobial agent can be effectively exposed onto the fiber surface, so that the inherent antibacterial and antiviral effects of the inorganic antimicrobial agent against pathogens such as bacteria and viruses can be fully exerted. Further, when it is designed and provided to have the same antibacterial and antiviral effects as a mask not having the above-described construction, the composition ratio of the inorganic antimicrobial agent can be reduced. Thus, the effect of reducing the product costs can be increased.

Further, with the above-described construction, productivity and performance can be improved. For example, when the fiber diameter of the first fiber layer 14 is set within the above-described range, compared with a construction in which it is smaller than the above-described range, decrease of productivity due to fiber breakage can be further prevented. Further, when the fiber diameter of the first fiber layer 14 is set within the above-described range, compared with a construction in which it is larger than the above-described range, the inorganic antimicrobial agent can be effectively exposed onto the fiber surface, so that the antibacterial and antiviral effects of the inorganic antimicrobial agent can be fully exerted. Further, when the particle diameter of the inorganic antimicrobial agent of the first fiber layer 14 is set within the above-described range, compared with a construction in which it is larger than the above-described range, decrease of productivity due to fiber breakage can be further prevented. Further, when the particle diameter of the inorganic antimicrobial agent of the first fiber layer 14 is set within the above-described range, compared with a construction in which it is smaller than the above-described range, the inorganic antimicrobial agent can be effectively exposed onto the fiber surface, so that the antibacterial and antiviral effects of the inorganic antimicrobial agent can be fully exerted.

### OTHER EMBODIMENTS

The present invention is not limited to the above embodiment, but rather, may be added to, changed, replaced with alternatives or otherwise modified. For example, the following provisions can be made in application of this embodiment.

In the above embodiment, the outer layer sheet 11 and the inner layer sheet 12 are described as being formed as a low-density pointbond nonwoven fabric sheet point-bonded by a pressure roll, but it is essential for the outer layer sheet 11 and the inner layer sheet 12 to be formed of nonwoven fabric having the fiber diameter of 10 to 40 μm. Thus, nonwoven fabric sheets other than the pointbond nonwoven fabric sheet may be used. For example, the outer layer sheet 11 and the inner layer sheet 12 may also be formed by a spun lace nonwoven fabric sheet manufactured by a spunlacing method, an air-through nonwoven fabric sheet manufactured by an air-through bonding method, or a spunbond nonwoven fabric sheet manufactured by a spunbonding method.

Further, in the above embodiment, the first fiber layer 14 of the intermediate layer sheet 13 is described as being disposed on the outer layer sheet 11 side (the outer side) of the second fiber layer 15, but in accordance with product specifications or the like, the second fiber layer 15 may be disposed on the outer layer sheet 11 side (the outer side) of the first fiber layer 14.

Further, in the above embodiment, both of the outer layer sheet 11 and the inner layer sheet 12 are described as being formed of fibers having a fiber diameter of 10 to 40 μm and a pore size of 60 to 100 μm, but the fiber diameter and the pore size of the outer layer sheet 11 and the inner layer sheet 12 do not necessarily have to be set within these ranges.

Further, in the above embodiment, the bonding parts 16 are described as being provided between the outer layer sheet 11 and the intermediate layer sheet 13 and between the inner layer sheet 12 and the intermediate layer sheet 13, but both or at least one of the bonding parts 16 may be dispensed with.

Further, in the above embodiment, the intermediate layer sheet 13 is described as being subjected to electret treatment in order to improve the capture efficiency of the mask, but whether it is subjected to electret treatment or not can be appropriately selected as necessary. For example, if it can achieve desired capture efficiency without being subjected to electret treatment, it does not necessarily have to be subjected to electret treatment.

Further, in the above embodiment, the mask body 10 is described as being formed by bonding the right and left sheet pieces 10a, 10b by heat-sealing, but the mask body can be formed by bonding at least one sheet in its entirety or in part by using various bonding methods including heat sealing.

Further, in the above embodiment, the mask is described as being of disposable type designed for a single or multiple use which can be used once or several times, but this invention can also be applied to a mask of reusable type which can be reused by washing, provided that the materials of the mask body and the ear straps are appropriately selected. Further, in this embodiment, the mask body is described as being three-dimensional, but this invention can also be applied to a mask having a planar mask body.

1. A mask comprising:
a mask body configured to cover at least wearer's mouth and nose; and
a pair of ear straps that extend from both sides of the mask body and are configured to be hooked around wearer's ears,
wherein:
the mask body includes
a first fiber sheet,
a second fiber sheet laid on the first fiber sheet such that the second fiber sheet is located on a wearer's side of the first fiber sheet when the mask is worn, and
the first fiber sheet comprises hydrophobic fibers,
the second fiber sheet includes a first fiber layer which is formed of polyolefin fibers containing an inorganic antimicrobial agent and a second fiber layer which is formed of polyolefin fibers and has a larger fiber diameter than the first fiber layer, wherein the fiber diameter of the first fiber layer is within a range of 0.5 to 2.8 μm and the ratio of a particle diameter of the inorganic antimicrobial agent with respect to the fiber diameter is within a range of 0.1 to 6.0,
a third fiber sheet laid on a side of the second fiber sheet facing away from the first fiber sheet,
the density of the first fiber layer is higher than a density of the first fiber sheet and a density of the third fiber sheet,
the density of the second fiber layer is higher than a density of the first fiber sheet and a density of the third fiber sheet.

2. The mask as defined in claim 1, wherein the first fiber layer of the second fiber sheet is disposed on the first fiber sheet side of the second fiber layer.

3. The mask as defined in claim 1, wherein the first fiber sheet is formed of hydrophobic fibers having a fiber diameter of 10 to 40 μm and a pore size of 60 to 100 μm.

4. The mask as defined in claim 1, wherein the mask body includes a bonding part which is formed between the first fiber sheet and the second fiber sheet by applying a hot-melt adhesive in fibrous form having a light basis weight of 1.0 to 3.0 g/m².
